(19) United States
(12) Patent Application Publication
(10) Pub. No.: US 2014/0114942 A1
(43) Pub. Date: Apr. 24, 2014

(54) Dynamic Pruning of a Search Index Based on Search Results

(71) Applicant: INTERNATIONAL BUSINESS MACHINES CORPORATION, Armonk, NY (US)

(72) Inventors: Igor L. Belakovskiy, Cambridge, MA (US); Matthew E. Broomhall, Burlington, VT (US); Itzhack Goldberg, Hadera (IL); Boaz Mizrachi, Haifa (IL); Neil Sondhi, Vac (HU)

(73) Assignee: INTERNATIONAL BUSINESS MACHINES CORPORATION, Armonk, NY (US)

(21) Appl. No.: 13/658,236

(22) Filed: Oct. 23, 2012

(51) Int. Cl. G06F 17/30

(52) U.S. Cl. 707/706; 707/715; 707/E17.017; 707/E17.002; 707/E17.108

(57) ABSTRACT

A search index for a collection of documents includes a plurality of keywords associated with the documents. Access to individual documents is detected based on searches employing the search index and keywords are recorded that are utilized in the searches and resulted in document access. The search index is modified to maintain the recorded keywords and remove keywords absent from the searches resulting in the document access.

### BACKGROUND

1. Technical Field

Present invention embodiments relate to database search indexes, and more specifically, to modifying or pruning a search index based on actual search results.

2. Discussion of the Related Art

Searching for information is performed in a wide variety of contexts from web-based browser initiated searches, to basic research, to finding customer related information, and the like. To perform searches, a database search engine is employed to search data sources or repositories to retrieve documents based on the terms employed by the search. The repositories contain collections of documents and other data. To improve search efficiency, the search engine will generate an index of the underlying data (e.g., the corpus) that allows a structured view of the underlying data, which are generally not adapted for search efficiency. In some cases the indexes (also referred to as “indices”) can consume as much or more storage space as the repository data. Accordingly, one issue with search indexes can be their large size. The larger the index, the longer the search time. Furthermore, some larger indexes will not fit into the available dynamic memory that facilitates timely search application index access. To alleviate these issues with respect to large indexes, database engineers will trim or reduce the size of the index using a technique referred to as index pruning.

Traditional approaches to pruning are performed statically (i.e., prior to performing any searches using the index). Index pruning removes language terms or other information from the index deemed irrelevant. In essence, a smaller version of the index is generated from a full or complete index. Static index pruning may rank terms based on predetermined criteria (e.g., relevance scores or term frequency) in order to determine which terms to remove. Other methods rely on inverted index pruning that remove index database table columns (or conceptually rows, depending on viewpoint) using a particular relationship vector (e.g., a term in the index that points to terms in documents in the data repository). As a document runs through its life cycle (e.g., document conception,document update cycle, and document obsolescence), the index must be updated, often frequently when indexing web sites. These traditional methods tend to induce latency and reduce search efficiency.

### BRIEF SUMMARY

According to one embodiment of the present invention, a system is provided for optimizing a search index by generating a search index for a collection of documents that includes a plurality of keywords associated with the documents. Access to individual documents is detected based on searches employing the generated search index. Recording is performed of keywords utilized in the searches that resulted in document access. The search index is modified to maintain the recorded keywords and remove keywords absent from the searches resulting in the document access. Embodiments of the present invention further include a method and computer program product for optimizing a search index in substantially the same manner described above.

### BRIEF DESCRIPTION OF THE SEVERAL VIEWS OF THE DRAWINGS

FIG. 1 is a diagrammatic illustration of an example computing environment for use with an embodiment of the present invention.

FIG. 2 is a procedural flow chart illustrating a manner in which a search index is optimized according to an embodiment of the present invention.

FIG. 3A is a diagrammatic illustration of an example search index document map prior to index pruning according to an embodiment of the present invention.

FIG. 3B is a diagrammatic illustration of an example search index document map after index pruning according to an embodiment of the present invention.

### DETAILED DESCRIPTION

Present invention embodiments optimize a search index (e.g., a database search engine index) by pruning the search index based on terms in searches employing the search index that actually result in accessing source documents by a user or other querying application. By using actual document retrieval as a dynamic basis for index pruning, smaller, more up-to-date, and more accurate indexes can be maintained.

For example, in traditional static indexing, indexing all documents on the web allows the various search engines to quickly present their relevant search results (e.g., hit lists). The indexes have one or more files that consume large amounts of storage and change frequently with each change of any underlying document in the various repositories. To reduce index size, typically stop-list words such as prepositions (e.g., “the”, “a”, “an”, etc.) are excluded from the index files as they do not help distinguish a particular document's relevancy, thereby making the index files more meaningful and manageable. A website is visited as a result of an assortment of searches, yet only a fraction of the words/phrases in the website's documents are actually used for the searches, and an even smaller number of those searches lead to an actual website visit.

Given this reduced set of search terms that actually result in a document viewing by a user, further index efficiencies may be obtained. By way of example, the search index that returned a result that was viewed by the user may be further pruned dynamically and as a direct result of actual viewings or retrievals (e.g., in addition to or in lieu of stop-list words and static pruning) by the user. Accordingly, dynamic pruning enhances the search infrastructure in terms of storage space need, as well as search efficiency. Eliminating words that do not result in successful searches can not only reduce the size of an index, but improve indexing and search performance, which is particularly useful on mobile devices

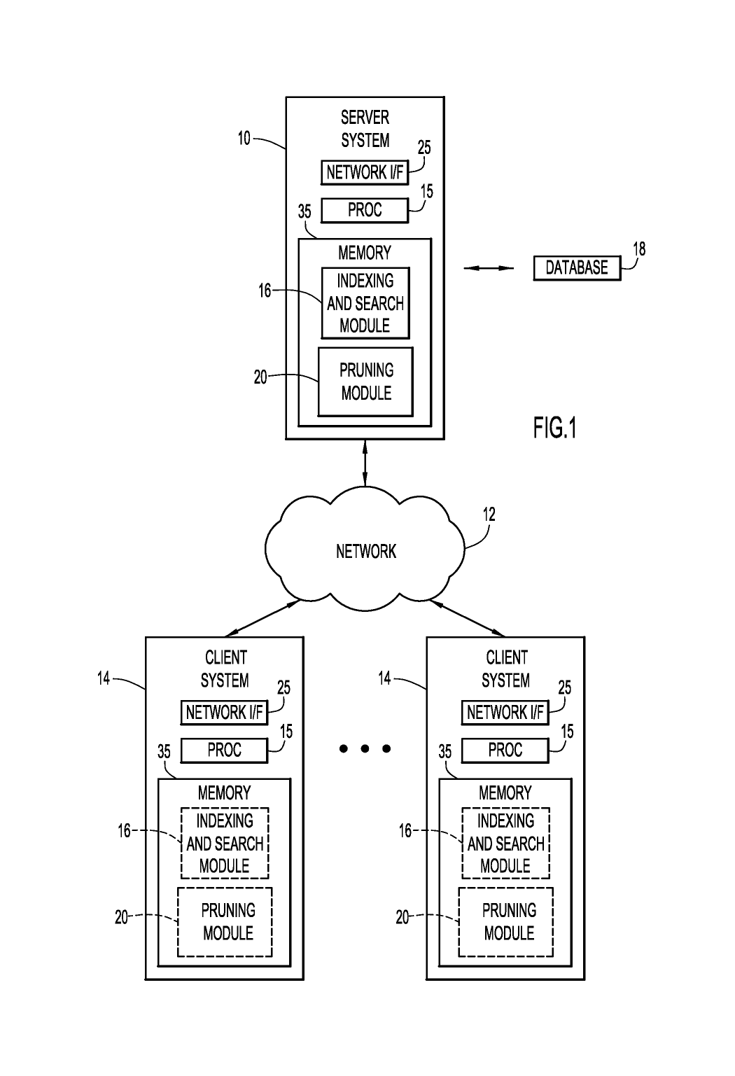

An example environment for use with present invention embodiments is illustrated in FIG. 1. Specifically, the environment includes one or more server systems 10, and one or more client or end-user systems 14. Server systems 10 and client systems 14 may be remote from each other and communicate over a network 12. The network may be implemented by any number of any suitable communications media (e.g., wide area network (WAN), local area network (LAN), Internet, Intranet, etc.). Alternatively, server systems 10 and client systems 14 may be local to each other, and communicate via any appropriate local communication medium (e.g., local area network (LAN), hardwire, wireless link, Intranet, etc.)

Server systems 10 and client systems 14 may be implemented by any conventional or other computer systems preferably equipped with a display or monitor (not shown), a base (e.g., including at least one processor 15, one or more memories 35 and/or internal or external network interfaces or communications devices 25 (e.g., modem, network cards, etc.)), optional input devices (e.g., a keyboard, mouse or other input device), and any commercially available and custom software (e.g., server/communications software, indexing module, pruning module, browser/interface software, etc.).

Client systems 14 may receive user query information related to desired documents (e.g., documents, pictures, news stories, etc.) to server systems 10. In another example, the information and queries may be received by the server, either directly or indirectly. The server systems include an indexing and search module 16 to generate an index of repository data (e.g., a web site or repository database index), and a pruning module 20 to analyze the database index based on a user query. A database system 18 may store various information for pruning the index (e.g., databases and indexes, sample collections of documents, and search results, etc.). The database system may be implemented by any conventional or other database or storage unit, may be local to or remote from server systems 10 and client systems 14, and may communicate via any appropriate communication medium (e.g., local area network (LAN), wide area network (WAN), Internet, hardwire, wireless link, Intranet, etc.). The client systems may present a graphical user interface (e.g., GUI, etc.) or other interface (e.g., command line prompts, menu screens, etc.) to solicit information from users pertaining to database queries, and may provide search results (e.g., document links, document relevance scores, etc.), such as in reports to the user, which client system 14 may present via the display or a printer or may send to another device/system for presenting to the user.

Alternatively, one or more client systems 14 may perform index pruning when operating as a stand-alone unit. In a stand-alone mode of operation, the client system stores or has access to the data (e.g., document links, document relevance scores, etc.), and includes indexing and search module 16 and pruning module 20 to perform index pruning. The graphical user interface (e.g., GUI, etc.) or other interface (e.g., command line prompts, menu screens, etc.) solicits information from a corresponding user pertaining to database searches, and may provide reports including search results (e.g., document links, document relevance scores, etc.).

Indexing and search module 16 and pruning module, 20 may include one pr more modules or units to perform the various functions of present invention embodiments described below. The various modules (e.g., indexing module, pruning module, etc.) may be implemented by any combination of any quantity of software and/or hardware modules or units, and may reside within memory 35 of the server and/or client systems for execution by processor 15.

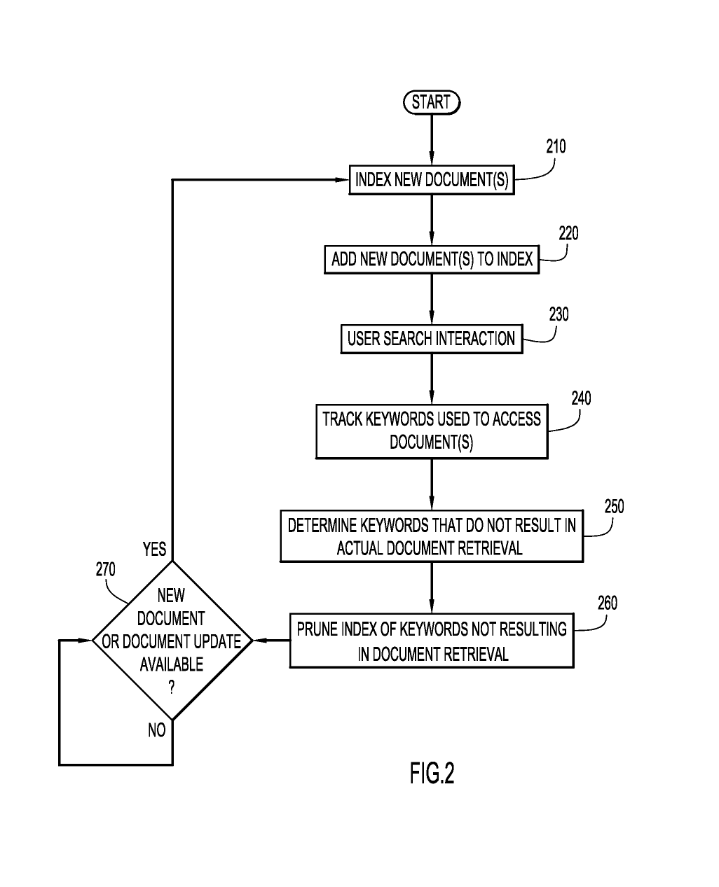

A manner in which indexing and search module 16 and pruning module 20 (e.g., via a server system 10 and/or client system 14) performs index pruning according to an embodiment of the present invention is illustrated in FIG. 2. Specifically, one or more new documents are indexed at step 210. The indexing information from the newly indexed documents is added to the index at step 220, or may be used to generate a new index if an index was not previously generated. The index may be stored as Extensible Markup Language (XML) tags that correspond to the structure of the original documents, or as data pointers into a document (e.g., a relative data address, a paragraph number, line number, character position, etc.). Accordingly, the index in one example may be a record that contains search terms or phrases, and tags or pointers to the source document or relevant portions thereof. Put another way, the index may contain search terms and their corresponding postings list (e.g., a list of documents, or portions thereof, for which a particular search term is applicable). Thus, the index forms an abbreviated representation of the source document.

Indexing and search module 16 may use or include text analysis engines (TAE) (also referred to as analysis engines or annotators) that implement the actual document analysis algorithms. Annotators create annotations that include meta-data information associated with a particular location or span in the original unstructured data or document. Examples of annotations that may be applied to text documents include annotations that identify sequences of characters as an entity name, an entity telephone number, product flavor, product size, etc. The text analysis engines (TAE) may be designed to interpret and account for common spelling errors, grammatical mistakes, and punctuation. In addition, advanced text analysis engine (TAE) functions may include identification of relationships between items or major topics discussed in the text.

Indexing and search module 16 provides a text analysis platform that acquires and transforms the wince documents, performs basic lingaistic processing (including language determination and tokenization), and stores the analyzed documents and extracted information in a search index for semantic search. The analyzed documents and extracted information may further be stored in a relational database for data mining on the discovered information.

Steps 210 and 220 may also be performed for both new and newly updated documents. Most documents go through a typical life-cycle: 1) the document is first conceived and later updated, 2) the document is used as-is by the public at large or within an entity, and 3) the document loses its initial appeal and relevancy (unless it is updated and as such starts its lifecycle again). Take, as an example, a World Wide Web (WWW) document or web site. The techniques described herein, can be used to monitor and track website visits which were a result of successful searches, i.e., the web site was opened as a result of the web browser query entered by a user. The opened website or accessed query result may be referred to as a successful access.

A further requirement for what is considered a viable web site successful access may be that the user spends a certain amount of time (e.g., 60 seconds or more) viewing the site (or viewing the retrieved document). Adding a time limit allows for a higher level of certainty and reduces false positives for those web or document access events in which the user opens the page and closes it rather quickly when the user determines that the opened web page did not have the desired subject matter. Another marker of successful access may be occurrence of an event in which a user further selects secondary documents that may be linked within the first accessed document (e.g., using a hyperlink).

A list of words, word combinations, and phrases may be maintained in a list. The “exported” list of words to be indexed is restricted just to those tracked words and phrases that result in a hit. By keying on successful search terms, the index becomes efficiently sized or “right-sized” with respect to the number of keyword entries in the respective index files, and results in reduced index storage space usage and enhanced search efficiencies (i.e., searches that traverse smaller index files). In other words, when the content of any site is indexed, not all the words in the site are vital for generating a desired search result. If the index is based on search terms resulting in successful visit to the site, then the size of the index can be reduced accordingly. Therefore, the search index can be based on logical combination of words successfully entered by user that results in desired content for the user. Any subsequent updates to the site can be monitored for these words or phrases. These words or phrases may be kept in a “successful visit word combination list” or other file. By using these techniques a search engine can increase the relevance of the search results, thereby making the search engine more effective for the end user.

User interaction with the search engine occurs at step 230. At this point, the user enters search terms that generate a query in order to retrieve desired documents or web sites. The queries may contain simple keywords or more complex grammar-like constructs. A query keyword represents an item of interest to the user. For example, the query may contain nouns, noun alternatives and plurals, conjunctions or other Boolean terms (e.g., not, or, and, and exclusive-or), etc. If the query contains a noun, the noun may be “package” and the alternatives are “packages,” “container,” and “containers,” where there is an implied “or” construct when alternatives are provided. Thus, the noun may be “package”, “packages”, “container”, or “containers”. Furthermore, Boolean query constructs may be used. For example, queries may be “term! AND not term2” or “term1 AND term2”.

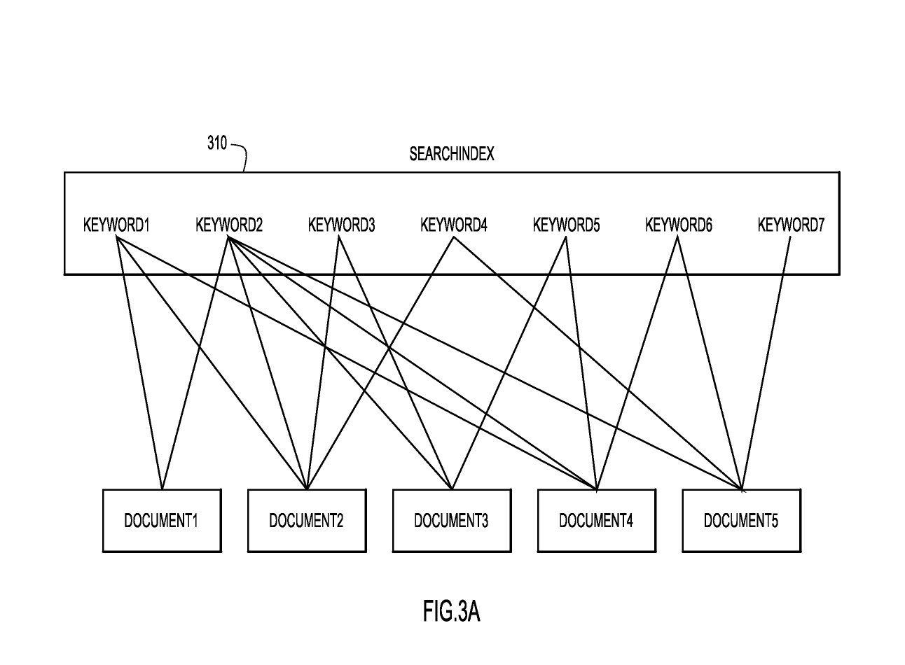

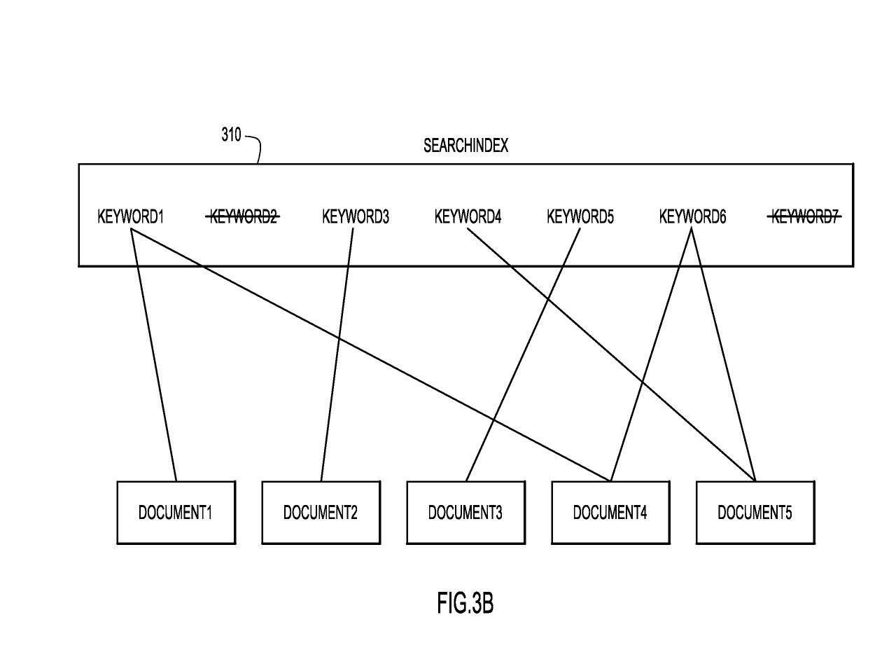

The query may be entered via a user interface or may be selected from a list of “canned” or predesigned queries. In this regard, the user may opt to store any given query for future use. Once the query is received by the search engine, the indexing and search module 16 searches the index as part of step 230. An example search index prior to pruning according to the techniques described herein is illustrated in FIG. 3A. Specifically, a search index 310 is shown with keywords labeled KEYWORD1 through KEYWORD7. Each keyword is mapped to one or more documents labeled DOCUMENT1 through DOCUMENT5. By way of example, KEYWORD1 is mapped to DOCUMENT1, DOCUMENT2, and DOCUMENT4, while KEYWORD7 is mapped to DOCUMENTS. Accordingly, if a user enters KEYWORD7, hen DOCUMENT5 would be returned as a query result (e.g., a result in the form of a document link, pointer, address, or web site locator).

Any matches to the received search query are returned and presented to the user. The search results may further contain information from the annotations in the index that enable the user to retrieve the original source documents to obtain additional information about the document or web site.

When a successful document access is obtained, the keywords used to obtain the successful access are tracked or recorded, and stored in a list at step 240, as described above. Once the list is built (e.g., over a predetermined time period or other predetermined events or conditions), it is determined which keywords within the index 310 do not result in an actual document retrieval at step 250. The index is pruned of keywords that do not result in actual document retrieval at step 260. An example search index after pruning is illustrated in FIG. 3B. As shown in FIG. 3B, KEYWORD2 and KEYWORD7 have been removed or otherwise deleted from index 310. As can be seen, the associated document links have also been removed, and the complexity of index 310 has been reduced when compared to index 310 shown in FIG. 3A. It is to be understood that the index illustrated in FIGS. 3A and 3B are greatly simplified to illustrate the basic concepts of index pruning using keywords that result in actual document retrieval according to the techniques provided herein.

To summarize steps 210 through 260, an initial search index is created from a corpus, as described above, using all or the most relevant known possible keywords. The index is exposed to users, who interact with it in a normal fashion, by conducting searches, and opening one more of the matching results produced from one or more key words. Individual documents in the corpus, e.g. emails or web pages, track when they are opened from a search page, and record the keywords used to find them. The search engine application, or other tracking mechanism or application may perform tracking or keyword recording.

When a large body of users has accessed the indexed database, it becomes more likely that those particular keywords resulting in document access are the most helpful keywords for uniquely identifying a particular document and that those particular keywords alone are sufficient for providing efficient access to the underlying document(s). Accordingly, in this heavy-use situation the index can safely be pruned of any keywords that did not result in a successful search, thereby removing all “dead” edges. More generally, the index may be pruned responsive to a predetermined time interval, a predetermined keyword frequency, or a predetermined number of document accesses.

To state the above in a different framework, a list of “stop words” (also referred to as a “stop list”) is a term typically used for words that are filtered out of query terms before performing a query. For example, this is usually done automatically for short words such as “a” and “the” or the like that occur frequently in common usage. Stated within this framework, present embodiments dynamically generate a stop list (e.g., KEYWORD2 and KEYWORD7 SHOWN in FIG. 3B) that is responsive to, and specific to, the corpus. The dynamic stop list technique provides further efficiency with respect to documents with static content, such as emails (immutable once sent in most systems), electronic books (e-books), and product manuals. Thus, these techniques result in much smaller search indices; a savings that can be particularly valuable regarding mobile devices.

In general, any of the source documents, successful access keyword lists, and indexes may be stored within database system 18, or locally on the server and/or client system performing the index pruning.

After initial pruning is performed at step 260, the indexing and pruning procedure may be terminated, re-initiated periodically, or upon a systemic trigger (e.g., by a watchdog timer, batch process trigger, or administrator). In this regard, the underlying indexed document may be monitored by a decision point at step 270 (i.e., the underlying repository or document database may be monitored). When the triggering condition is detected at 270 (e.g., expiration of a certain time frame, a document update, or the addition of a new document to the repository), steps 210 through 260 may be responsively repeated. Thus, step 270 may be performed in response to numerous triggers, including internal monitoring and external notification. Otherwise, step 270 waits.

It will be appreciated that the embodiments described above and illustrated in the drawings represent only a few of the many ways of implementing dynamic pruning of a search index based on search results.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser software, communications software, server software, indexing module, pruning module, etc.). These systems may include any types of monitors and input devices (e.g., keyboard, mouse, voice recognition, etc.) to enter and/or view information.

It is to be understood that the software (e.g., indexing module, pruning module, etc.) of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments (e.g., indexing module, pruning module, etc.) may be available on a recordable or computer useable medium (e.g., magnetic or optical mediums, magneto-optic mediums, floppy diskettes, CD-ROM, DVD, memory devices, etc.) for use on stand-alone systems or systems connected by a network or other communications medium.

The communication network may be implemented by any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., documents, document collections, search results, keyword lists, indexes, pruned indexes, etc.). The database system may be implemented by any number of any conventional or other databases, data stores or storage structures (e.g., files, databases, data structures or tables, data or other repositories, etc.) to store information (e.g., documents, document collections, search results, keyword lists, indexes, pruned indexes, etc.). The database system may be included within or coupled to the server and/or client systems. The database systems and/or storage structures may be remote from or local to the computer or other processing systems, and may store any desired data (e.g., documents, document collections, search results, keyword lists, indexes, pruned indexes, etc.). Further, the various tables (e.g., keyword lists, indexes, pruned indexes, etc.) may be implemented by any conventional or other data structures (e.g., files, arrays, lists, stacks, queues, etc.) to store information, and may be stored in any desired storage unit (e.g., database, data or other repositories, etc.).

Present invention embodiments may be utilized for determining any desired index pruning information (e.g., keywords, etc.) from any type of document (e.g., speech transcript, web or other pages, word processing files, spreadsheet files, presentation files, electronic mail, multimedia, etc.) containing text in any written language (e.g. English, Spanish, French, Japanese, etc.). The potential cause information may pertain to any type of company or entity operations (e.g., manufacturing, internal processes and workflows, hardware and software product development, etc.).

The indexes may be developed in any manner (e.g., manually developed, based on a template, etc.) and contain any type of data (names, nouns, verbs, numbers, etc.) and/or rules (e.g., grammatical, lexical, or mathematical constructs). The indexes may be designed in any manner that facilitates tagging or document searching and analysis by an analysis engine or annotator. The indexes may be in any format (e.g., plain text, relational database tables, nested XML code, etc.). Any number of indexes may be used for document searching.

Indexes may be developed using any manner of analysis (e.g., linguistic, semantic, statistical, machine learning, natural language processing, etc.). Index development may use any form of information retrieval and lexical analysis to analyze word frequency distributions, and perform pattern recognition, tagging, annotation, information extraction, and/or data mining. Index development techniques may include link and association analysis, visualization, and predictive analytics.

The present invention embodiments may employ any number of any type of user interface (e.g., Graphical User Interface (GUI), command-line, prompt, etc.) for obtaining or providing information (e.g., documents, document collections, search results, keyword lists, indexes, pruned indexes, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized for pruning indexes associated with any type of documents.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (Java and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method of optimizing a search index comprising:
generating a search index for a collection of documents including a plurality of keywords associated with the documents;
detecting access to individual documents based on searches employing the generated search index and recording keywords utilized in the searches that resulted in document access; and
modifying the search index to maintain the recorded keywords and remove keywords absent from the searches resulting in the document access.

2. The method of claim 1, wherein generating the search index includes one or more of generating the search index periodically, upon an update to the collection of documents, and in response to a triggering event.

3. The method of claim 1, wherein detecting document access includes detecting document access for a predetermined period of time.

4. The method of claim 1, wherein detecting document access includes detecting document access to a first document and subsequent document access to a second document linked to the first document.

5. The method of claim 1, wherein recording keywords includes recording by one or more of the accessed document, a search engine, and an application associated with maintaining the search index.

6. The method of claim 1, wherein recording keywords includes recording one or more of a frequency of keywords, recording keywords for a predetermined period of time, and recording keywords for a predetermined number of times a document is accessed.

7. The method of claim 1, further comprising ranking keywords resulting in document access according one or more of keyword search frequency, keyword frequency within an accessed document, keyword relevance to the accessed document.

8. The method of claim 7, wherein modifying includes removing keywords based on keyword rank.

9. A system for dynamic pruning of a search index comprising:
a computer system including at least one processor configured to:
generate a search index for a collection of documents including a plurality of keywords associated with the documents;
detect access to individual documents based on searches employing the generated search index and recording keywords utilized in the searches that resulted in document access; and
modify the search index to maintain the recorded keywords and remove keywords absent from the searches resulting in the document access.

10. The system of claim 9, wherein generating the search index includes one or more of generating the search index periodically, upon an update to the collection of documents, and in response to a triggering event.

11. The system of claim 9, wherein detecting document access includes detecting document access for a predetermined period of time.

12. The system of claim 9, wherein detecting document access includes detecting document access to a first document and subsequent document access to a second document linked to the first document.

13. The system of claim 9, wherein recording keywords includes recording by one or more of the accessed document, a search engine, and an application associated with maintaining the search index.

14. The system of claim 9, wherein recording keywords includes recording one or more of a frequency of keywords, recording keywords for a predetermined period of time, and recording keywords for a predetermined number of times a document is accessed.

15. The system of claim 9, further comprising ranking keywords resulting in document access according one or more of keyword search frequency, keyword frequency within an accessed document, keyword relevance to the accessed document.

16. The system of claim 15, wherein modifying includes removing keywords based on keyword rank.

17. A computer program product for dynamic pruning of a search index comprising:
a computer readable storage medium having computer readable program code embodied therewith, the computer readable program code comprising computer readable program code configured to:
generate a search index for a collection of documents including a plurality of keywords associated with the documents;
detect access to individual documents based on searches employing the generated search index and recording keywords utilized in the searches that resulted in document access; and
modify the search index to maintain the recorded keywords and remove keywords absent from the searches resulting in the document access.

18. The computer program product of claim 17, wherein generating the search index includes one or more of generating the search index periodically, upon an update to the collection of documents, and in response to a triggering event.

19. The computer program product of claim 17, wherein detecting document access includes detecting document access for a predetermined period of time.

20. The computer program product of claim 17, wherein detecting document access includes detecting document access to a first document and subsequent document access to a second document linked to the first document.

21. The computer program product of claim 17, wherein recording keywords includes recording by one or more of the accessed document, a search engine, and an application associated with maintaining the search index.

22. The computer program product of claim 17, wherein recording keywords includes recording one or more of a frequency of keywords, recording keywords for a predetermined period of time, and recording keywords for a predetermined number of times a document is accessed.

23. The computer program product of claim 17, further comprising ranking keywords resulting in document access according one or more of keyword search frequency, keyword frequency within an accessed document, keyword relevance to the accessed document.

24. The computer program product of claim 23, wherein modifying includes removing keywords based on keyword rank.
